(19) United States
(12) Patent Application Publication
(10) Pub. No.: US 2003/0189496 A1
(43) Pub. Date: Oct. 9, 2003

(54) Central management of networked computers

(76) Inventor: Matthew P. Tran, Chandler, AZ (US)

Correspondence Address: KENYON & KENYON, 1500 K STREET, N.W., SUITE 700, WASHINGTON, DC, 20005, US

(21) Appl. No.: 10/117,076

(22) Filed: Apr. 8, 2002

(51) Int. Cl. H04Q 9/00; G08C 19/16

(52) U.S. Cl. 340/870.07; 340/870.11

(57) ABSTRACT

A computer network includes a client computer and a main computer. The client computer includes a client controller coupled to a plurality of sensors. The main computer includes a main controller. The main controller and client controller are coupled to a bus. The plurality of sensors generate operating parameter data about the components, and the client controller receives the operating parameter data and converts it into a simplified protocol.

### FIELD OF THE INVENTION

Embodiments of the present invention are directed to computer networks. More particularly, embodiments of the present invention are directed to central management of networked computers.

### BACKGROUND INFORMATION

In their infancy, computers were primarily stand-alone units. Although large mainframe or server computers typically were connected to “dumb” terminals, all of the processing power was centralized in the server.

However, today the majority of computers, especially in business settings, are networked together. Computer networks range in size from two or three computers merely sharing a printer and files, to large networks that can include tens of thousands of computers.

One challenge in deploying a large network of computers is the monitoring and management of all of the computers. In large networks, there are advantages in managing most of the resources from a central location, rather than having to individually monitor and manage each computer from potentially thousands of different physical locations.

Based on the foregoing, there is a need for system and method for the central management of computers.

### BRIEF DESCRIPTION OF THE DRAWINGS

The following is a brief description of the drawings, wherein like numerals indicate like elements throughout:

FIG. 1 is a block diagram of a computer network that includes centralized management.

FIG. 2 is a block diagram of a computer network that includes centralized management in accordance with one embodiment of the present invention.

FIG. 3 is a flow diagram of the functions performed by a computer network in accordance with one embodiment of the present invention.

### DETAILED DESCRIPTION

One embodiment of the present invention is a system having a client controller in each client server that collects sensor information, analyzes it, and converts the information into a standardized format. The data is collected by a main controller which determines if there are faults in any client servers.

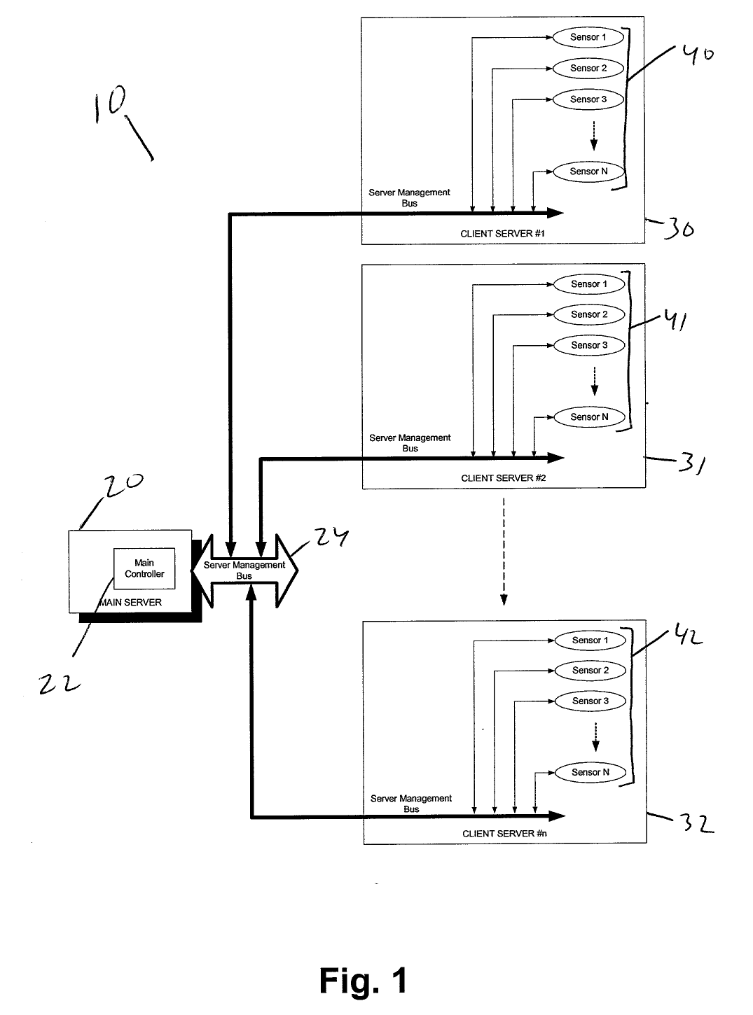

FIG. 1 is a block diagram of a computer network 10 that includes centralized management. Network 10 includes a plurality of client server computers 30-32. Client server computers 30-32 typically are connected to additional computers or networks (not shown). Each client server computer 30-32 includes a plurality of sensors 40-42 that monitor the health of various components within the server system such as the temperature, voltage and operating parameters.

Network 10 further includes a main server computer 20 that is coupled to sensors 40-42 through a server management bus 24. Main server 20 includes a main controller 22. Main controller 22 collects all data from sensors 40-42 over server bus 24 by individually polling each sensor one by one. The data is then processed to determine if a fault has been detected at client servers 30-32.

One problem with the remote monitoring as done by network 10 is the sheer amount of data that must be transmitted over server bus 24 because of the large amount of sensors. The amount of data increases exponentially as the number of client servers that must be managed increase. The increased amount of data consequently slows down the speed in which main server 20 can manage the network.

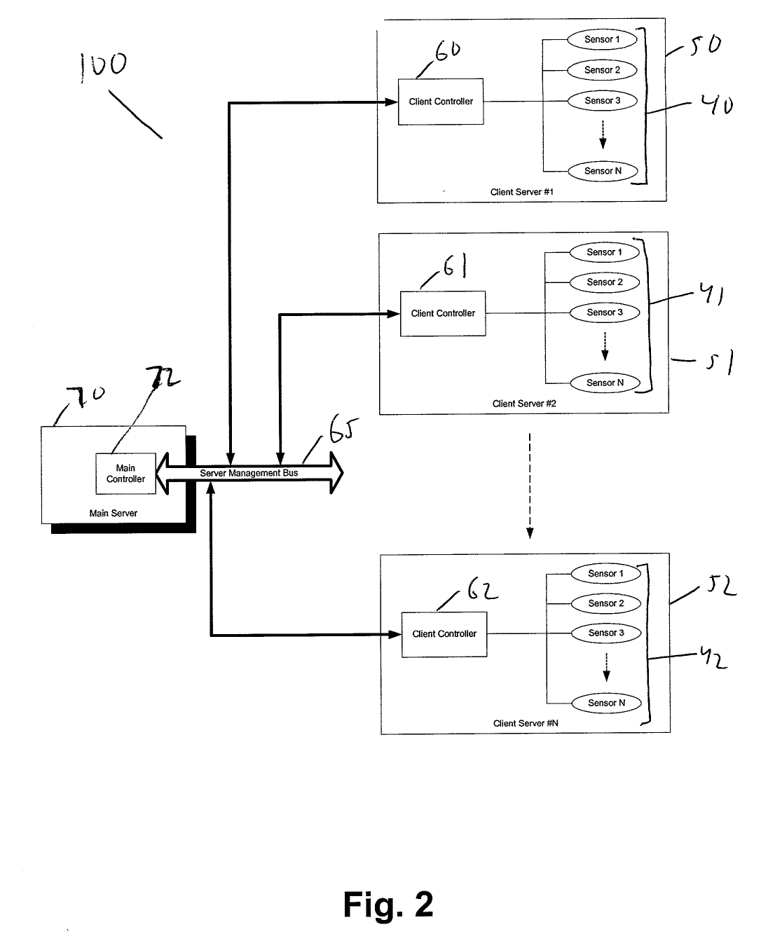

FIG. 2 is a block diagram of a computer network 100 that includes centralized management in accordance with one embodiment of the present invention. Network 100 includes a plurality of client server computers 50-52. Additional “client” devices such as other computers or networks may be coupled to client server computers 50-52 (not shown). In one embodiment, client server computers 50-52 are general purpose servers and have a main processor and memory, including Random Access Memory (“RAM”), Read Only Memory (“ROM”) and disk type memory. In one embodiment, the processor is the Pentium 4 processor from Intel Corp.

Each client server computer 50-52 includes a plurality of sensors 40-42 that monitor the health of various components within the server system by generating operating parameters. Examples of operating parameters of components include temperature, voltage, rotating speed, number of soft errors, etc. Examples of components that are monitored by sensors 40-42 include a processor, memory, fan, circuit board, integrated circuit, hard drive, power supply, etc. Sensors 40-42 may be temperature measurement devices, voltage measurement devices, etc.

Each client server 50-52 further includes a client controller 60-62 that is coupled to the respective group of sensors 40-42. Client controllers 60-62 gather all data from sensors 40-42, analyze the data, and then convert the data in a standardized format as described in more detail below. The functionality of client controllers 60-62 can be implemented by the main processor of client servers 50-52, by a separate processor, or by specialized hardware.

Network 100 further includes a main server computer 70 that includes a main controller 72. Main server computer 70, like client servers 50-52, includes a processor and memory. Main controller 72 is coupled to client controllers 60-62 through a server management bus 65. Main controller 72 collects the data from client controllers 60-62 and determines if any corrective actions are needed. In one embodiment, server management bus 65 is a serial bus such as an Inter IC (“I²C”) bus, a System Management Bus (“SMBus”) or an Ethernet bus. In other embodiments, any type of network bus can be used.

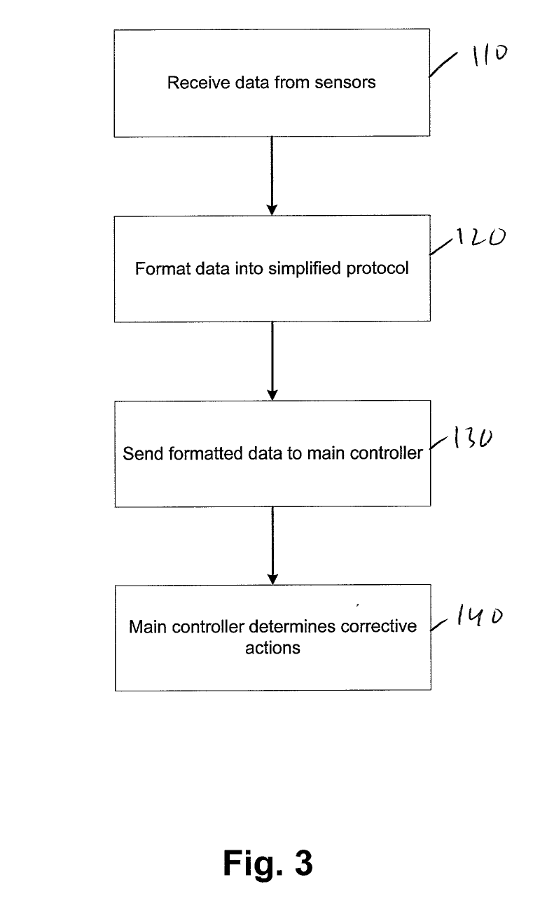

FIG. 3 is a flow diagram of the functions performed by computer network 100 in accordance with one embodiment of the present invention. In one embodiment, the functionality is implemented by software stored in memory and executed by processors. In other embodiments, the functions can be performed by hardware, or any combination of hardware and software.

At box 110, each client controller 60-62 receives data from its respective sensors 40-42. In one embodiment, the client controller receives the data by separately polling each sensor until the entire set of sensors has been polled.

At box 120, each client controller 60-62 formats or converts the received data into a simplified protocol. Therefore, the actual value read and reported by each sensor, such as an actual temperature reading or a revolution per minute (“RPM”) of a fan, is converted into the simplified protocol.

In one embodiment, the simplified protocol is a two-bit status for each sensor based on pre-set thresholds. In this embodiment, the following two-bit protocol is implemented:

| | |
|---|---|
| Device normal: | 00 |
| Device has minor problem: | 01 |
| Device has major problem: | 10 |
| Device has critical problem: | 11 |

At box 130, the formatted data from client controllers 60-62 is sent to main controller 72. In one embodiment, main controller 72 receives the data by separately polling each client controller until all of client controllers 60-62 have been polled.

At box 140, main controller 72 determines if any corrective actions are required based on the received formatted data. For example, any indications of critical problems will result in an alert being sent to a system administrator with an identity of which component is having problems. Main controller 72 can also take corrective action by itself. For example, if necessary, main controller 72 can increase the speed of a fan or shut down individual components in order to cool a server computer.

As shown, one embodiment of the present invention consolidates and formats data at the client server, with each client controller handling all sensors within one server. Main controller 72 does not need to poll every individual sensor to get data; it simply polls client controllers 60-62 to get the status of all sensors. Since the number of client controllers is less than the number of sensors, there will be much less time needed for main controller 72 to complete a round of sensor data polling. The result is a faster server management data transfer rate, an easier way of interpreting data and a much simpler method to add a new server to the network in the future.

As an example of the reduced data transfer requirement of one embodiment of the present invention, I²C is used for the server management bus and all sensors are designed with an I²C port. To read/write data from/to an I²C device, two bytes are required in a 7-bit address scheme, a first byte to address the device and the second byte that is the payload. The data transfer rate for this embodiment can be expressed as follows:

Data transfer rate=(#sensors per server*2 bytes)+(#server*2 bytes)

Where:

(#sensors per server*2 bytes) represents the number of bytes the client controller needs to gather the sensor data in one server; and

(#server*2 bytes) represents the number of bytes the main controller needs to gather data from the client controller.

Assuming that every server in the network is designed with the same number of sensors, in one embodiment server management network 100 includes 5 client servers with 4 sensors for each client controller. According to the above formula, the data transfer rate for the embodiment is:

(4*2 bytes)+(5*2 bytes)=18 bytes

In comparison, if prior art network 10 of FIG. 1 was implemented, there would be no client controller and the main controller must access every sensor to get data. The data transfer rate for the prior art implementation would be:

(# sensors per server*2 bytes)*(# servers); or

(4 sensors*2 bytes)*(5 servers)=40 bytes

As shown, it takes 40 bytes in the prior art network versus only 18 bytes in the embodiment of the present invention to complete a round of data polling. The result is a speed improvement of 40/18=2.22 times for the above example.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A computer network comprising:
a client computer, said client computer comprising:
a client controller; and
a plurality of sensors coupled to said client controller;
a bus coupled to said client computers; and
a main computer coupled to said bus, said main computer comprising a main controller.

2. The computer network of claim 1, wherein said client computer comprises a plurality of components coupled to said plurality of sensors, said plurality of sensors generating operating parameter data about said components, and said client controller receiving the operating parameter data and converting it into a simplified protocol.

3. The computer network of claim 1, wherein said simplified protocol comprises a two-bit status for each of said sensors.

4. The computer network of claim 2, said main controller receiving said simplified protocol.

5. The computer network of claim 4, said main computer determining a corrective action based on said simplified protocol.

6. The computer network of claim 1, wherein said bus is an Ethernet bus.

7. The computer network of claim 1, wherein said sensors comprise a temperature measurement device and a voltage measurement device.

8. A method of remotely managing a computer network comprising:
by receiving operating parameter data of a component from a sensor;
converting the operating parameter data into a simplified protocol; and
sending the simplified protocol to a main controller.

9. The method of claim 8, said converting comprising:
comparing the operating parameter data to a plurality of threshold values; and
assigning a value based on one of the threshold values.

10. The method of claim 8, said simplified protocol comprising a two-bit status.

11. The method of claim 8, wherein said converting is performed at a client controller.

12. The method of claim 11, wherein said client controller and said main controller are coupled to a bus.

13. The method of claim 12, wherein said bus is an Ethernet bus.

14. The method of claim 11, further comprising sending a second simplified protocol from a second client controller.

15. The method of claim 8, further comprising:
initiating corrective action at the main controller.

16. A computer readable medium having instructions stored thereon that, when executed by a processor, cause the processor to:
receive operating parameter data of a component from a sensor;
convert the operating parameter data into a standardized format; and
send the simplified protocol to a main controller.

17. The computer readable medium of claim 16, said standardized format comprising a simplified protocol.

18. The computer readable medium of claim 17, said processor converts by: comparing the operating parameter data to a plurality of threshold values; and assigning a value based on one of the threshold values.

19. The computer readable medium claim 17, said simplified protocol comprising a two-bit status.

20. The computer readable medium claim 17, wherein said processor is located at a client controller.

21. The computer readable medium claim 20, wherein said client controller and said main controller are coupled to a bus.

22. The computer readable medium claim 21, wherein said bus is an Ethernet bus.
